(19) United States
(12) Patent Application Publication
(10) Pub. No.: US 2011/0109890 A1
(43) Pub. Date: May 12, 2011

(54) LIGHT SOURCE APPARATUS, EXPOSURE APPARATUS, AND ELECTRONIC DEVICE MANUFACTURING METHOD

(76) Inventor: Hideki KOMATSUDA, Ageo-shi (JP)

(21) Appl. No.: 12/900,956

(22) Filed: Oct. 8, 2010

Related U.S. Application Data
(63) Continuation of application No. PCT/JP2009/000338, filed on Jan. 29, 2009.
(60) Provisional application No. 61/071,045, filed on Apr. 9, 2008.

(51) Int. Cl. G03B 27/54

(52) U.S. Cl. 355/67

(57) ABSTRACT

There is provided a light source apparatus for emitting light having a uniform intensity distribution. Such a light source apparatus for generating a light beam to be projected toward a fly-eye optical system included in an exposure apparatus includes a light source, and a mirror that reflects the light beam emitted from the light source toward the fly-eye optical system. Here, the mirror reflects the light beam from the light source such that the light beam projected toward the fly-eye optical system has a lower intensity in the edge portion than in the center portion. The mirror may reflect the light beam such that the intensity of the light beam projected toward the fly-eye optical system monotonically decreases in the edge portion. Furthermore, the mirror may reflect the light beam such that the intensity of the light beam projected toward the fly-eye optical system decreases down to zero in the edge portion.

### CROSS REFERENCE TO RELATED APPLICATION

The contents of the following U.S. Provisional Application and PCT Application are incorporated herein by reference,
No. 61/071,045 filed on Apr. 9, 2008 and
No. PCT/JP2009/000338 filed on Jan. 29, 2009.

### BACKGROUND

1. Technical Field

The present invention relates to a light source apparatus, an exposure apparatus, and an electronic device manufacturing method. More specifically, the present invention relates to a light source apparatus for generating exposure light to be used for photolithography, an exposure apparatus including the light source apparatus, and an electronic device manufacturing method using the exposure apparatus.

2. Related Art

In an exposure apparatus used for lithography, light is generated by a light source, emitted as illumination light toward a reticle through an illumination optical system, transmitted or reflected by the reticle, and emitted as exposure light toward a wafer through a projection optical system. In this way, a photosensitive material applied onto the wafer is exposed to the light.

In the above-described exposure apparatus, the illumination light emitted from the illumination optical system toward the reticle preferably has a uniform illuminance distribution. To realize such illumination light with a uniform illuminance distribution, use of a fly-eye lens, fly-eye reflecting mirror or the like has been proposed or put into practice as disclosed, for example, in Japanese Patent Application Publication No. 2006-019510.

However, the above-described device may not produce sufficient effects of a uniform illuminance distribution and may leave a significant non-uniform illuminance distribution in the illumination light.

### SUMMARY

Therefore, it is an object of an aspect of the innovations herein to produce illumination light with a uniform illuminance distribution. The above and other objects can be achieved by combinations described in the claims.

To solve the above-described problems, a first embodiment of the present invention provides a light source apparatus for generating a light beam to be projected toward a fly-eye optical system included in an exposure apparatus. Here, the light beam entering the fly-eye optical system has a lower intensity in an edge portion than in a center portion. The light source apparatus may include a light source, and an optical system that projects the light beam emitted from the light source toward the fly-eye optical system. The optical system may project the light beam such that the light beam has a lower intensity in the edge portion than in the center portion.

A second embodiment of the present invention provides a light source apparatus for generating a light beam to be projected toward a fly-eye optical system of an exposure apparatus. The light source apparatus includes a light source and a mirror that reflects the light beam emitted from the light source toward the fly-eye optical system positioned at a predetermined plane. The mirror reflects the light beam from the light source such that the light beam has a lower intensity in an edge portion than in a center portion at the predetermined plane.

A third embodiment of the present invention provides an exposure apparatus including the above-described light source apparatus, a fly-eye optical system, and an illumination optical system that illuminates a predetermined pattern by using the light from the light source apparatus.

A fourth embodiment of the present invention provides an electronic device manufacturing method using the above-described exposure apparatus. The electronic device manufacturing method includes exposing a substrate to light having a predetermined pattern, developing the substrate to which the predetermined pattern has been transferred to form a mask layer shaped in accordance with the predetermined pattern on a surface of the substrate, and processing the surface of the substrate through the mask layer.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

An exposure apparatus relating to the present invention can emit a light beam having a uniform illuminance distribution to a to-be-exposed surface.

### BRIEF DESCRIPTION OF THE DRAWINGS

FIG. 1 schematically illustrates the structure of an exposure apparatus 100.

FIGS. 2A and 2B are front views illustrating the structures of fly-eye reflecting mirrors 134 and 136.

FIG. 3 is a cross-sectional view illustrating the shape of a collective reflecting mirror 132.

FIG. 4 is an enlarged cross-sectional view illustrating the shape of a portion of the collective reflecting mirror 132.

FIG. 5 illustrates the intensity distribution of the light exiting from the collective reflecting mirror 132.

FIGS. 6A to 6F respectively illustrate the illuminance distributions of the light beams reflected by component optical systems 134a of the fly-eye reflecting mirror 134.

FIGS. 7A to 7F respectively illustrate the illuminance distributions of the light beams reflected by the component optical systems 134a of the fly-eye reflecting mirror 134.

FIGS. 8A and 8B illustrate illuminance distributions at a to-be-exposed surface.

FIG. 9 is a plan view illustrating the shape of a light block plate 131.

FIG. 10 is a partial enlarged cross-sectional view illustrating a different structure for the collective reflecting mirror 132.

FIG. 11 is a partial enlarged cross-sectional view illustrating a further different structure for the collective reflecting mirror 132.

FIG. 12 is a cross-sectional view illustrating a yet different structure for the collective reflecting mirror 132.

FIG. 13 is a cross-sectional view illustrating the shape of an optical member 139 constituting the collective reflecting mirror 132.

FIG. 14 illustrates the illuminance distribution of the collective reflecting mirror 132.

FIG. 15 is a flow chart illustrating an exemplary electronic device manufacturing method utilizing the exposure apparatus 100 including a light source 120.

FIG. 16 is a flow chart illustrating another exemplary electronic device manufacturing method utilizing the exposure apparatus 100 including the light source 120.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

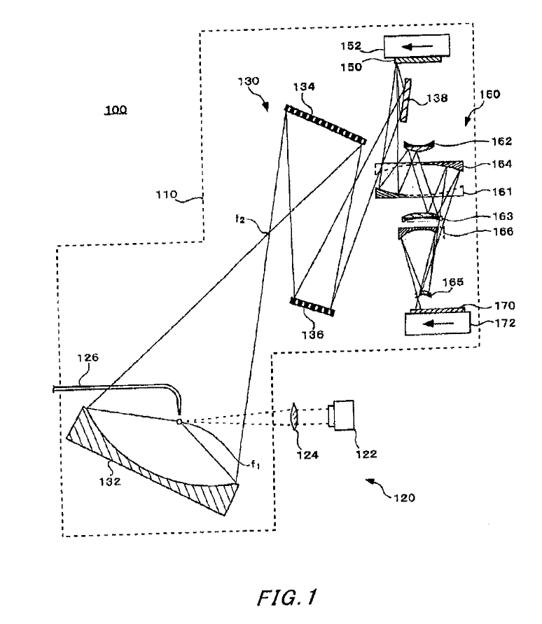

FIG. 1 schematically illustrates the overall structure of the exposure apparatus 100. The exposure apparatus 100 is constituted by a light source 120, an illumination optical system 130, a reticle stage 152, a projection optical system 160, and a wafer stage 172.

Most of the components of the exposure apparatus 100 are housed within an air-tight vacuum chamber 110, but some of the components of the light source 120 are provided outside the vacuum chamber 110. In the following description, relative terms such as “upper,” “lower,” “above,” “below,” and the like may be used when describing the examples depicted in the drawings. However, the layout of the components of the exposure apparatus 100 is not limited to those illustrated in the drawings.

The light source 120 includes a laser device 122, a collective lens 124, a target nozzle 126, and a collective reflecting mirror 132. The laser device 122 generates laser light and emits the generated laser light toward the inside of the vacuum chamber 110 through the collective lens 124.

The target nozzle 126 ejects a gaseous or liquid target material from its end, which is positioned within the vacuum chamber 110. The collective reflecting mirror 132 has a reflective surface whose cross-sectional shape is an elliptical arc, and is positioned such that the laser light is applied to the target material at one focus f1 of the elliptical arc.

In the light source 120, the target nozzle 126 intermittently ejects the target material. The laser light emitted from the laser device 122 is converged by the collective lens 124 and applied to the ejected target material with high density. Thus, the target material is transformed into plasma and emits extreme ultraviolet pulses. The emitted extreme ultraviolet light is collected by the collective reflecting mirror 132 to the other focus f2 of the reflective surface of the collective reflecting mirror 132, turned into divergent light, and then guided to the illumination optical system 130. In the present embodiment, the collective reflecting mirror 132 is shown as an exemplary optical system. The optical system, however, is not limited to a collective reflecting mirror and can be a transmissive optical member such as a lens.

The illumination optical system 130 includes a pair of fly-eye reflecting mirrors 134 and 136 constituting a fly-eye optical system, and a planar reflecting mirror 138. The entry-side fly-eye reflecting mirror 134 has a plurality of concave mirrors arranged in parallel lines and is provided at or in the vicinity of the position that is optically conjugate with the reticle 150 or wafer 170 (the to-be-exposed surface), which serves as a to-be-irradiated surface or exposed surface (described later). The EUV light enters the entry-side fly-eye reflecting mirror 134, is reflected by the entry-side fly-eye reflecting mirror 134, and then enters the exit-side fly-eye reflecting mirror 136. The exit-side fly-eye reflecting mirror 136 has a plurality of concave mirrors arranged in parallel lines and is provided at or in the vicinity of the pupil plane of the illumination optical system.

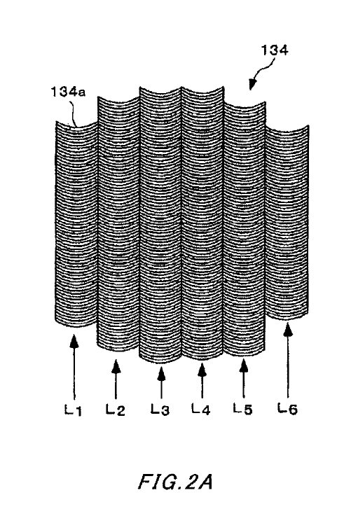

FIGS. 2A and 2B are front views illustrating the structures of the fly-eye reflecting mirrors 134 and 136. FIG. 2A illustrates the entry-side fly-eye reflecting mirror 134 and FIG. 2B illustrates the exit-side fly-eye reflecting mirror 136.

Component optical systems 134a of the entry-side fly-eye reflecting mirror 134 are arranged in a one-to-one correspondence with component optical systems 136a of the exit-side fly-eye reflecting mirror 136. The component optical systems 134a and 136a have the same focal distance. Here, the component optical systems 134a and 136a can each include a concave mirror. The component optical systems 134a of the entry-side fly-eye reflecting minor 134 are arranged in a plurality of lines L1 to L6.

Referring back to FIG. 1, upon entrance into the entry-side fly-eye reflecting mirror 134, the light is wavefront-split into a plurality of light beams by the component optical systems 134a of the entry-side fly-eye reflecting mirror 134. The light beams produced by the wavefront-splitting of the entry-side fly-eye reflecting mirror 134 enter the exit-side fly-eye reflecting mirror 136. The component optical systems 136a of the exit-side fly-eye reflecting mirror 136 receive, in a one-to-one correspondence, the light beams produced by the wavefront-splitting. Since the component optical systems 134a of the entry-side fly-eye reflecting mirror 134 are optically conjugate with the to-be-exposed surface on the wafer 170, the exit-side fly-eye reflecting mirror 136 acts as a surface light source compatible with Köhler illumination.

The light exiting the fly-eye reflecting mirror 136 enters the planar reflecting mirror 138 at a small incident angle and is reflected to the reticle 150. Here, the component optical systems 136a of the exit-side fly-eye reflecting mirror 136 are arranged on a predetermined concave surface. In other words, the exit-side fly-eye reflecting mirror 136 also serves as a condenser optical system. Thus, the light beams respectively reflected by the component optical systems 136a of the exit-side fly-eye reflecting mirror 136 illuminate the reticle 150 in an overlapping manner.

The reticle 150 is held by the reticle stage 152 with its reflective surface facing downward. The reticle 150 is formed by using a glass substrate or the like, and has a reflective layer formed by a multi-layer film and an absorptive layer that covers a portion of the surface of the reflective layer, for example.

The reflective layer reflects extreme ultraviolet light. The absorptive layer absorbs extreme ultraviolet light. Accordingly, the light beam reflected by the reticle 150 has an illuminance distribution according to the pattern of the absorptive layer, and afterward enters the projection optical system 160.

The projection optical system 160 includes a plurality of concave reflecting mirrors 161, 164 and 166, and a plurality of convex reflecting mirrors 162, 163, and 165. The projection optical system 160 forms, as a whole, a minification optical system for converging the light reflected by the reticle 150. The concave reflecting mirrors 161, 164 and 166 and the convex reflecting mirrors 163 and 165 are shaped as if partly cut off, so as not to obstruct the propagation of the reflected light beams through the projection optical system 160. The projection optical system 160 may be provided with an optical characteristics compensating section for compensating for imaging characteristics, wavefront aberration, and other characteristics, although not shown.

The light beam reflected by the reticle 150 is sequentially reflected by the reflecting mirrors 161 to 166, and then emitted to the surface of the wafer 170 held on the upper surface of the wafer stage 172. The light beam emitted to the wafer 170 has an intensity distribution patterned in accordance with the shape of the absorptive layer of the reticle 150. Here, a photosensitive photoresist is applied to the surface of the wafer 170.

The reticle stage 152 and the wafer stage 172 can move in the horizontal direction. The reticle 150 and the wafer 170 respectively held by the reticle stage 152 and the wafer stage 172 accordingly move as the reticle stage 152 and the wafer stage 172 move.

Thus, the reticle stage 152 and the wafer stage 172 can be synchronously moved while the wafer 170 is exposed to the light from the reticle 150 in the exposure apparatus 100. This approach is referred to as scan exposure. The present embodiment employs the step-and-scan exposure according to which the process of the scan exposure and the process of moving (stepping) the wafer 170 relative to the reticle 150 are repeatedly carried out. Alternatively, the step-and-repeat exposure may be employed according to which the process of exposing the wafer 170 to the light from the reticle 150 with both of the reticle 150 and the wafer 170 being kept stationary and the process of moving (stepping) the wafer 170 relative to the reticle 150 are repeatedly carried out.

As stated above, the wafer 170, which is to be exposed to light by the exposure apparatus 100, may be moved in the scan direction while being exposed to light. Taking this exposure approach into consideration, the collective reflecting mirror 132 may reflect the light symmetrically in a non-scan direction that is substantially perpendicular to the scan direction. The collective reflecting minor 132 may include a plurality of mirrors that are arranged symmetrically in the non-scan direction that is substantially perpendicular to the scan direction. Thus, the collective reflecting mirror 132 with a larger reflective area can be easily manufactured.

According to the above-described configuration, the light source 120 of the exposure apparatus 100 generates extreme ultraviolet light, but may be designed to output other wavelengths such as g line (436 nm), i line (365 nm), KrF exima laser (248 nm), F₂ laser (157 nm), Kr₂ laser (146 nm), and Ar₂ laser (126 nm).

Thus, there is provided the light source 120 for generating a light beam to be projected toward the fly-eye reflecting mirror 134 of the exposure apparatus 100 including the fly-eye reflecting mirrors 134 and 136. The light source 120 includes the collective reflecting mirror 132 that reflects the generated light beam toward the fly-eye reflecting mirror 134. There is also provided the exposure apparatus 100 including the light source 120, the fly-eye reflecting mirrors 134 and 136, and the illumination optical system 130 that illuminates the reticle 150 by using the light from the light source 120.

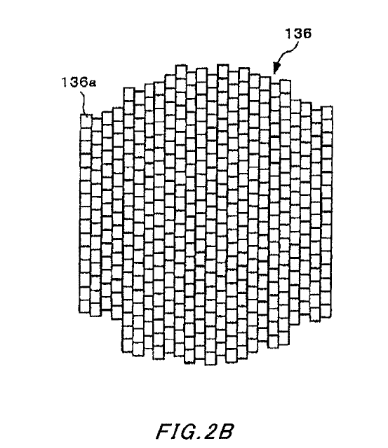

FIG. 3 is a cross-sectional view illustrating the shape of the reflective surface of the collective reflecting minor 132. The collective reflecting mirror 132 has a reflective surface with a radius D1. The reflective surface is divided into a center portion C that centers around the central axis A and an edge portion E that externally surrounds the center portion C.

The center portion C has a substantially elliptical arc cross-section. The edge portion E is smoothly contiguous with the center portion C. However, the gradient of the reflective surface varies, in terms of the radial direction, differently between the center portion C and the edge portion E.

Specifically speaking, the center portion C is shaped like an elliptical arc in cross-section, and reflects the extreme ultraviolet light generated at one of the focuses of the elliptical arc. As a result, the reflected extreme ultraviolet light is directed to the other of the focuses of the elliptical arc. In the edge portion E, on the other hand, the gradient of the reflective surface successively varies so that the reflected light deviates toward the outer periphery of the collective reflecting mirror 132 from the above-mentioned other focus of the elliptical arc.

As described above, the collective reflecting mirror 132 may have a curved reflective surface whose curvature is set such that, when the surface is radially divided into the center portion C and the edge portion E, a predetermined point in the center portion C has a different curvature from a predetermined point in the edge portion E. In other words, the collective reflecting mirror 132 may have a curved reflective surface whose curvature differs between at the portion that produces the reflected light corresponding to the center portion of the light beam that will reach a predetermined plane, at which the fly-eye reflecting mirror 134 is provided, and at the portion that produces the reflected light corresponding to the edge portion of the light beam that will reach the predetermined plane. Here, the respective portions are differently positioned in the radial direction, and the fly-eye reflecting mirror 134 is one of the two fly-eye optical minors that is positioned upstream. With the above-described configuration, the light beam exiting from the collective reflecting mirror 132 has a unique illuminance distribution, as will be described.

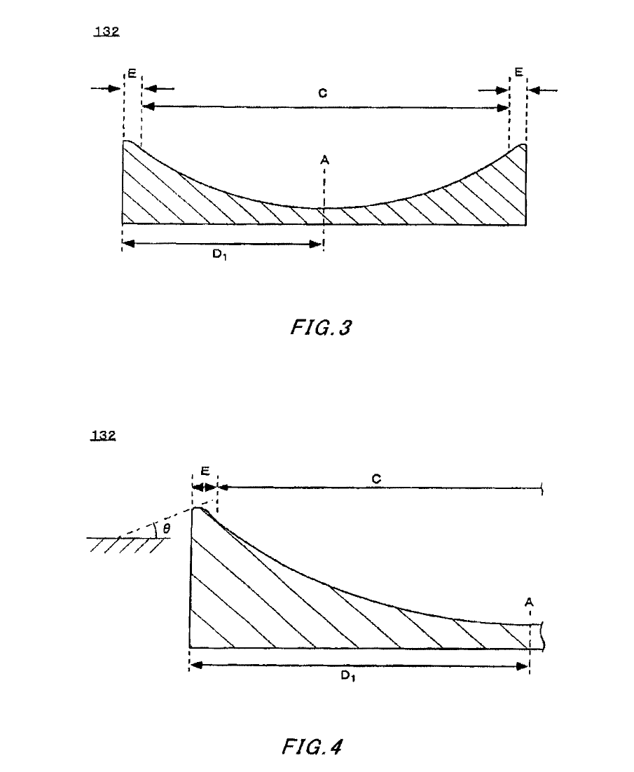

FIG. 4 is an enlarged cross-sectional view illustrating the shape of a portion of the collective reflecting mirror 132. As shown in FIG. 4, the gradient of the tangent line to the reflective surface is reversed at the outmost periphery of the edge portion E of the collective reflecting mirror 132 so as to form a positive angle with respect to the plane perpendicular to the central axis A.

Thus, the extreme ultraviolet light reflected by the outmost periphery of the collective reflecting mirror 132 does not enter the fly-eye reflecting mirror 134 and becomes divergent. The collective reflecting mirror 132 may be configured to reflect the extreme ultraviolet light in such a manner that the intensity of the light beam projected toward the fly-eye reflecting mirror 134 is reduced down to zero in the edge portion.

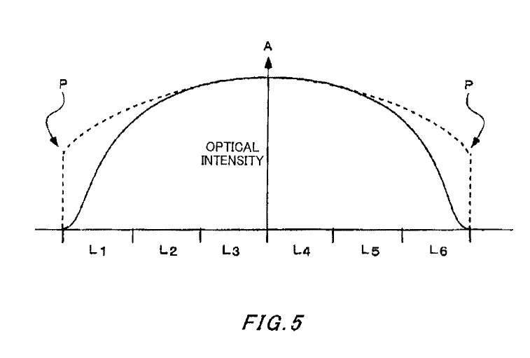

FIG. 5 illustrates the illuminance distribution of the light beam, at a predetermined plane at which the entrance-side fly-eye reflecting mirror 134 is positioned, that is reflected by the collective reflecting mirror 132 and emitted toward the entrance-side fly-eye reflecting mirror 134. In FIG. 5, the vertical axis represents the optical intensity A and the horizontal axis represents a position on the predetermined plane along one particular direction. Note that the left-right or horizontal direction in FIG. 2A is selected as the one particular direction of FIG. 5, which additionally illustrates the lines L1 to L6 of the component optical systems 134a of the entrance-side fly-eye reflecting mirror 134. As illustrated in FIG. 5, the reflected light beam from the center portion C has such an illuminance distribution that the optical intensity constantly varies. On the other hand, the optical intensity of the reflected light beam from the edge portion E successively varies at a different rate until reaching zero at the outmost periphery.

If the edge portion E is not formed, that is to say, if the curvature varies in the edge portion E in the same manner as in the center portion C, the optical intensity keeps varying constantly until the outmost periphery of the collective reflecting mirror 132 as shown by the dotted line in FIG. 5. In this case, the optical intensity distribution has steep edges P at the respective ends since the optical intensity suddenly disappears at the outmost periphery of the reflected light beam from the outmost periphery of the collective reflecting mirror 132.

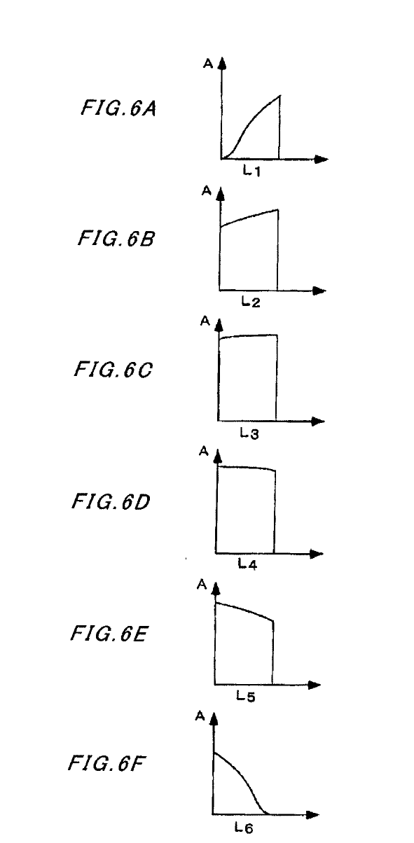

FIGS. 6A to 6F respectively illustrate the illuminance distributions of the light beams, at the to-be-exposed surface, that are reflected by the component optical systems 134a of the entrance-side fly-eye reflecting mirror 134, when the collective reflecting mirror 132 has the edge portion E. FIG. 6A illustrates the illuminance distribution of the light beam, at the to-be-exposed surface, that is reflected by a component optical system 134a arranged in the line L1, FIG. 6B illustrates the illuminance distribution of the light beam, at the to-be-exposed surface, that is reflected by a component optical system 134a arranged in the line L2, FIG. 6C illustrates the illuminance distribution of the light beam, at the to-be-exposed surface, that is reflected by a component optical system 134a arranged in the line L3, FIG. 6D illustrates the illuminance distribution of the light beam, at the to-be-exposed surface, that is reflected by a component optical system 134a arranged in the line L4, FIG. 6E illustrates the illuminance distribution of the light beam, at the to-be-exposed surface, that is reflected by a component optical system 134a arranged in the line L5, and FIG. 6F illustrates the illuminance distribution of the light beam, at the to-be-exposed surface, that is reflected by a component optical system 134a arranged in the line L6.

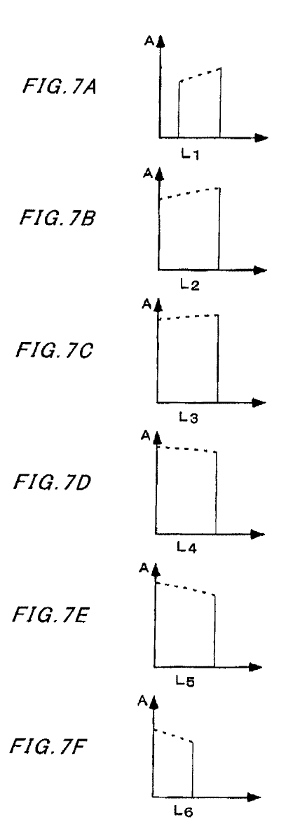

FIGS. 7A to 7F respectively illustrate the illuminance distributions of the light beams, at the to-be-exposed surface, that are reflected by the component optical systems 134a of the entrance-side fly-eye reflecting mirror 134, when the collective reflecting mirror 132 does not have the edge portion E. FIG. 7A illustrates the illuminance distribution of the light beam, at the to-be-exposed surface, that is reflected by a component optical system 134a arranged in the line L1, FIG. 7B illustrates the illuminance distribution of the light beam, at the to-be-exposed surface, that is reflected by a component optical system 134a arranged in the line L2, FIG. 7C illustrates the illuminance distribution of the light beam, at the to-be-exposed surface, that is reflected by a component optical systems 134a arranged in the line L3, FIG. 7D illustrates the illuminance distribution of the light beam, at the to-be-exposed surface, that is reflected by a component optical system 134a arranged in the line L4, FIG. 7E illustrates the illuminance distribution of the light beam, at the to-be-exposed surface, that is reflected by a component optical system 134a arranged in the line L5, and FIG. 7F illustrates the illuminance distribution of the light beam, at the to-be-exposed surface, that is reflected by a component optical system 134a arranged in the line L6.

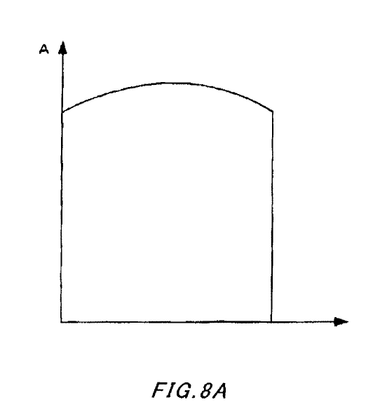

FIGS. 8A and 8B illustrate the illuminance distributions at the to-be-exposed surface. FIG. 8A illustrates the illuminance distribution at the to-be-exposed surface when the collective reflecting mirror 132 has the edge portion E, and FIG. 8B illustrates the illuminance distribution at the to-be-exposed surface when the collective reflecting mirror 132 does not have the edge portion E. Note that the illuminance distribution shown in FIG. 8A is obtained by adding together the illuminance distributions shown in FIGS. 6A to 6F and the illuminance distribution shown in FIG. 8B is obtained by adding together the illuminance distributions shown in FIGS. 7A to 7F.

As described earlier, the individual component optical systems 134a of the entrance-side fly-eye reflecting mirror 134 are optically conjugate with the to-be-exposed surface. Therefore, if the illuminance distribution of the light beam reflected from one component optical system 134a contains a steep edge P as shown in FIGS. 7A and 7F, this steep edge results in high-frequency components such as step-like differences in the illuminance distribution at the to-be-exposed surface as shown in FIG. 8B. Such high-frequency components in the illuminance distribution are extremely difficult to be corrected even by using illuminance distribution correcting means such as an illuminance distribution correcting filter or variable slit.

As described above, the fly-eye reflecting mirrors 134 and 136 can flatten an illuminance distribution containing a change within a range larger than the diameter of one component optical system (a concave reflecting mirror), but cannot flatten an illuminance distribution containing a radical change within a smaller range than the diameter of one component optical system. Thus, the light beam emitted from the illumination optical system 130 still has a non-uniform illuminance distribution. Consequently, the photoresist on the wafer 170 cannot be uniformly exposed to light.

On the other hand, when the illuminance distribution of the light beam reflected by one component optical system 134a does not contain a steep edge P as shown in FIGS. 6A to 6F, the resulting illuminance distribution contains no high-frequency components such as step-like differences as shown in FIG. 8A. Therefore, the illuminance distribution can be flattened by using illuminance distribution correcting means such as an illuminance distribution correcting filer or variable slit. The respective ends of the illuminance distribution of the light beam entering the fly-eye reflecting mirror 134 do not need to be reduced to as low as zero, provided that the height of the edge P falls within an acceptable range.

As described above, the light source 120 is configured such that the collective reflecting mirror 132 reflects the light beam in such a manner that the light beam projected toward the fly-eye reflecting mirror 134 has a lower intensity in the edge portion than in the center portion C. The collective reflecting mirror 132 may be designed to reflect the light in such a manner that the intensity of the light beam projected toward the fly-eye reflecting mirror 134 successively decreases in the edge portion. Furthermore, the collective reflecting mirror 132 may reflect the extreme ultraviolet light in such a manner that the intensity of the light beam projected toward the fly-eye reflecting mirror 134 monotonically decreases in the edge portion E. Thus, no steep optical intensity edges P are formed in the edge portion of the light beam, and the fly-eye reflecting mirrors 134 and 136 can thus flatten the illuminance distribution of the incoming light beam.

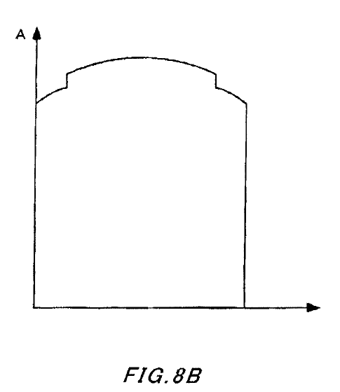

FIG. 9 is a plan view illustrating the shape of a light block plate 131 that is used to achieve the illuminance distribution shown in FIG. 5. The light block plate 131 has, as a whole, a larger diameter than the reflective surface of the collective reflecting mirror 132 and has an opening whose diameter is larger than the diameter of the light beam emitted from the collective reflecting mirror 132. The light block plate 131 has a large number of protrusions 133 protruding toward the inside of the opening. Each protrusion 133 successively decreases in width towards its free end or toward the center of the opening.

When the above-described light block plate is provided immediately before the collective reflecting mirror 132, the protrusions 133 block the vicinity of the outer periphery of the light beam emitted from the collective reflecting mirror 132. Here, increasingly less light is blocked toward the center of the light beam. Thus, the illuminance distribution shown in FIG. 5 can be obtained for the light beam.

When the above-described light block plate 131 is utilized, the collective reflecting mirror 132 does not need to have the special shape. Here, the shape of the light block plate 131 is not limited to the shape shown in FIG. 9. Alternatively, light block regions may be more densely arranged toward the edge portion E. For example, the light block plate 131 may be formed as a mesh structured such that the aperture ratio decreases toward the edge portion E.

As described above, the exposure apparatus 100 may include the light block plate 131, on the optical path extending from the collective reflecting mirror 132 to the fly-eye reflecting mirror 134, that is structured such that the light block regions are more densely arranged from the center portion C toward the edge portion E. Thus, the optical intensity distribution of the light beam entering the fly-eye reflecting mirrors 134 and 136 can be prevented from having the steep edges P. Accordingly, the reticle 150 can be irradiated with a light beam having a uniform illuminance distribution.

The light block plate 131 structured such that the light block regions are more densely arranged from the center portion C toward the edge portion E may be alternatively provided at the collective reflecting mirror 132. In other words, the light block plate 131 may be coaxially attached to the collective reflecting mirror 132, or a layer that does not transmit the light beam may be provided on the reflective surface of the collective reflecting mirror 132. This produces similar effects as the case where the light block plate 131 is arranged on the optical path of the light beam.

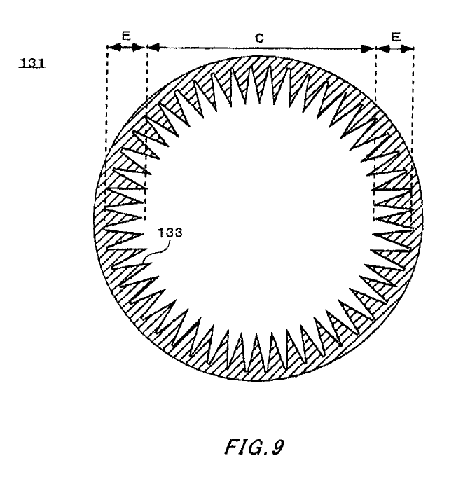

FIG. 10 is a partial enlarged cross-sectional view illustrating a different structure for the collective reflecting mirror 132. As shown in FIG. 10, the collective reflecting mirror 132 has a support 135 formed by a glass or metal, and a multi-layer film 137 formed on the upper surface of the support 135. The multi-layer film 137 may be formed by alternately layering Mo and Si layers. The multi-layer film 137 can efficiently reflect extreme ultraviolet light or the like by selecting an appropriate total thickness.

In the edge portion E of this collective reflecting mirror 132, the number of the layers constituting the multi-layer film 137 becomes smaller toward the outer periphery. This structure can achieve a reflectance distribution in which the reflectance decreases toward the outer periphery. Such a reflectance distribution can be also obtained by changing the thickness of the multi-layer film 137, in addition to by changing the number of layers constituting the multi-layer film 137.

As described above, the collective reflecting mirror 132 may be structured such that the reflectance is lower in the edge portion E than in the center portion C. Thus, the optical intensity distribution of the light beam entering the fly-eye reflecting mirrors 134 and 136 can be prevented from having the steep edges P. Accordingly, the reticle 150 can be irradiated with a light beam having a uniform illuminance distribution.

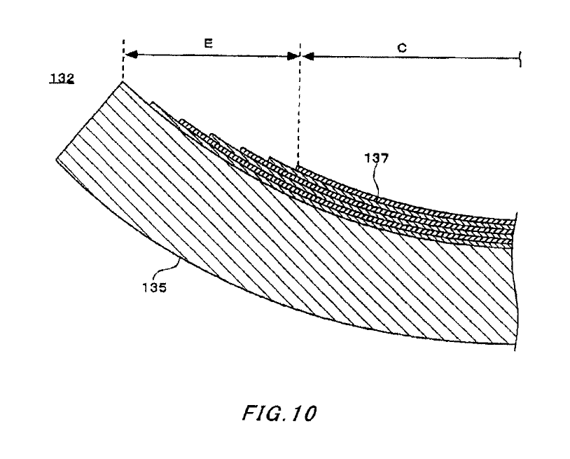

FIG. 11 illustrates a further different structure for the collective reflecting mirror 132. According to this structure, the collective reflecting mirror 132 also has a support 135 and a multi-layer film 137 formed on the surface of the support 135, and the multi-layer film 137 functions as a reflective layer. The surface of the multi-layer film 137 is roughened in the edge portion E. The rough surface in the edge portion E is made more rough toward the outer periphery of the collective reflecting mirror 132.

As described above, the collective reflecting mirror 132 may be designed such that the surface is more roughened in the edge portion E than in the center portion C. Thus, the optical intensity distribution of the light beam entering the fly-eye reflecting mirrors 134 and 136 can be prevented from having the steep edges P. Accordingly, the reticle 150 can be irradiated with a light beam having a uniform illuminance distribution.

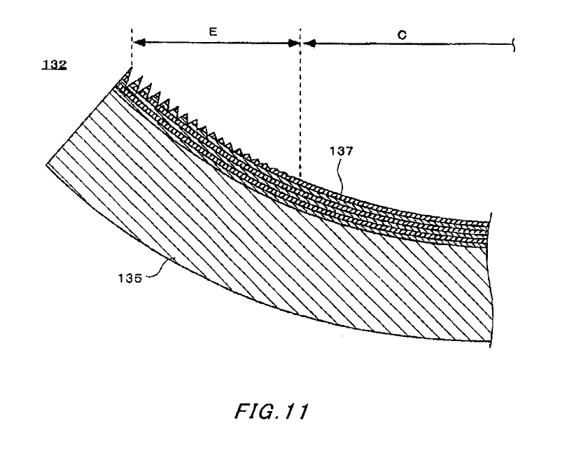

FIG. 12 is a cross-sectional view illustrating a yet different structure for the collective reflecting mirror 132. According to this embodiment, the collective reflecting mirror 132 includes a plurality of optical members 139 and a light block plate 131.

The optical members 139 each receive and reflect part of the extreme ultraviolet light emitted from the light source 120. The optical members 139 each have a curved reflective surface that converges the reflected light toward a predetermined focus.

In the middle of the collective reflecting mirror 132, part of the extreme ultraviolet light emitted from the light source 120 does not enter the optical members 139. The light block plate 131 is provided on the optical path of the light beam that proceeds without entering the optical members 139.

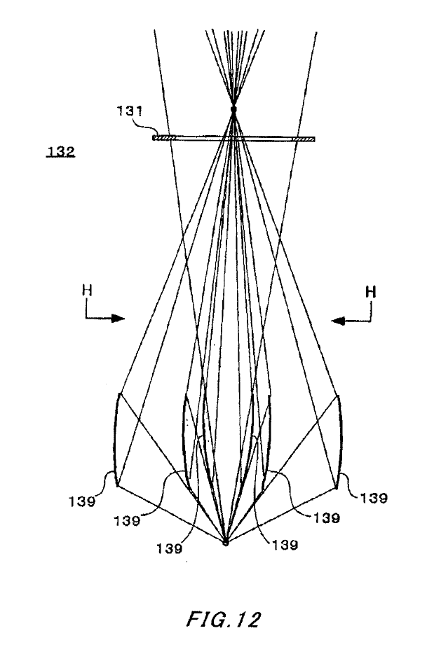

FIG. 13 is a cross-sectional view illustrating the shape of the optical members 139 constituting the collective reflecting mirror 132 shown in FIG. 12. The optical members 139 each have, in its center portion C, a curved surface shaped like an elliptical arc that converges the reflected light toward a predetermined focus. In the edge portion E of the optical member 139, the curvature varies at a different rate than in the center portion C, similarly to the collective reflecting mirror 132 shown in FIGS. 3 and 4.

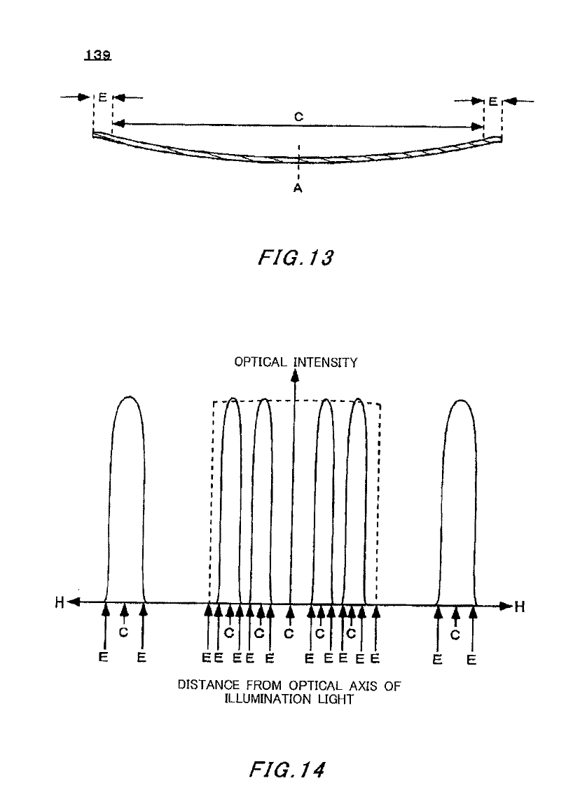

FIG. 14 illustrates the illuminance distributions of the light beams at the position indicated by the arrows H in FIG. 12. The illuminance distributions of the reflected light beams from the respective optical members 139 are indicated by solid lines in FIG. 14. As seen from FIG. 14, the optical intensity is made lower, down to substantially zero, in the edge portion E than in the center portion C in each light beam. Thus, upon receiving these light beams, the fly-eye reflecting mirror 134 generates illumination light having a uniform illuminance distribution without steep edges.

Here, the light beam that is emitted from the light source 120 and proceeds without entering the optical members 139 has the optical intensity distribution indicated by the dotted line in FIG. 14. This light beam is defined in width by the innermost optical members 139 and thus presents a rapid decrease in optical intensity in the edge portion E.

As shown in FIG. 12, however, the light block plate 131 is provided on the optical path of the light beam that is emitted from the light source 120 and proceeds without entering the optical members 139. Thus, the optical intensity of this light beam is successively reduced in the edge portion before the light beam enters the fly-eye reflecting mirror 134. Accordingly, the fly-eye reflecting mirrors 134 and 136 achieve a uniform illuminance distribution.

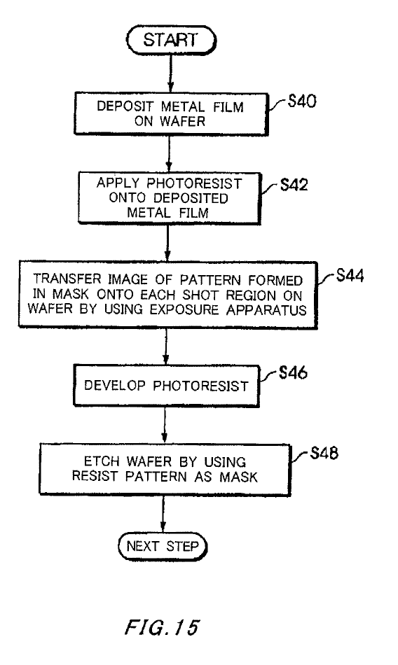

FIG. 15 is a flow chart illustrating a semiconductor device manufacturing method utilizing the exposure apparatus 100 including the light source 120. According to the semiconductor device manufacturing method, a metal film is deposited onto the wafer 170, which serves as a substrate of a semiconductor device (step S40). On the deposited metal film, a photosensitive material such as a photoresist is applied (step S42).

Subsequently, an exposing step is performed by using the exposure apparatus 100. Specifically speaking, the pattern formed in the reticle 150 is transferred to each of the shot regions on the wafer 170 (step S44). In other words, the photoresist on the wafer 170 is exposed to light whose intensity distribution is in accordance with the pattern. Thus, the photoresist is patterned by the light.

Furthermore, a developing step is performed on the wafer 170 onto which the pattern has been transferred during the exposure step. Specifically speaking, the photoresist is developed (step S46). After this, the surface of the wafer 170 is processed, for example, subjected to etching or the like by using as a mask the resist pattern formed by the exposure and wash (step S48).

Here, the resist pattern represents a resist layer that is formed by keeping or removing the region of the photoresist corresponding to the pattern transferred by the exposure apparatus 100 and covers a portion of the surface of the wafer 170 in accordance with the pattern. In the step S48, the resist pattern is used as a mask while the surface of the wafer 170 is processed. The techniques used to process the wafer 170 include at least one of the etching of the surface of the wafer 170, deposition of a metal film or the like, and etching of a metal film or the like.

As described above, an electronic device manufacturing method is performed by using the exposure apparatus 100. The manufacturing method includes the exposing step of exposing the wafer 170 to light having a predetermined pattern, the developing step of developing the wafer 170 onto which the predetermined pattern has been transferred to form on the surface of the wafer 170 a mask layer shaped in accordance with the predetermined pattern, and the processing step of processing the surface of the wafer 170 through the mask layer.

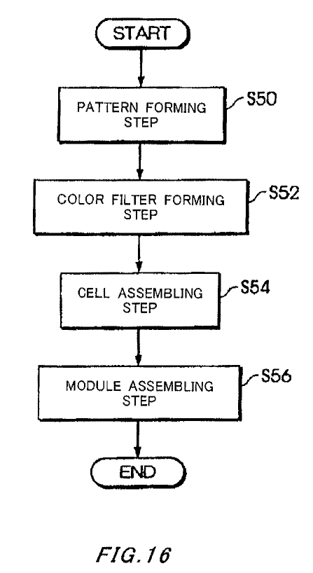

FIG. 16 is a flow chart illustrating a manufacturing method for a liquid crystal device such as a liquid crystal display element, utilizing the exposure apparatus 100 including the light source 120. This liquid crystal device manufacturing method includes a pattern forming step (step S50), a color filter forming step (step S52), a cell assembling step (step S54), and a module assembling step (step S56), which are sequentially performed.

In the pattern forming step or step S50, a predetermined pattern such as a circuit pattern and an electrode pattern is formed on a plate P, which is a glass substrate on which a photoresist is applied, by using the projection exposure apparatus relating to any of the embodiments. The pattern forming step includes an exposing step of transferring a pattern onto the photoresist layer by using the projection exposure apparatus relating to any of the embodiments, a developing step of developing the plate P on which the pattern has been transferred, that is to say, developing the photoresist layer on the glass substrate to form a photoresist layer shaped in accordance with the pattern, and a processing step of processing the surface of the glass substrate through the developed photoresist layer.

In the color filter forming step or step S52, a large number of sets of three dots corresponding to R (Red), G (Green), and B (Blue) are arranged in a matrix, or a plurality of filter sets of R, G and B three stripes are arranged so as to be adjacent to each other in the horizontal scan direction, so that color filters are formed.

In the cell assembling step or step S54, the glass substrate on which the predetermined pattern has been formed in the step S50 and the color filters that have been formed in the step S52 are used to assemble a liquid crystal panel (a liquid crystal cell). Specifically speaking, the liquid crystal panel is obtained, for example, by injecting liquid crystal between the glass substrate and the color filers.

In the module assembling step or step S56, electrical circuits, backlight, and other components are attached to the liquid crystal panel that has been assembled in the step S54, in order to enable the liquid crystal panel to have display functionality.

The use of the above-described light source apparatus, exposure apparatus, and electronic device manufacturing method is not limited to the semiconductor device manufacturing process. For example, the above-described light source apparatus, exposure apparatus, and electronic device manufacturing method can be also applied to manufacture a wide range of devices including liquid crystal display devices, plasma display devices, imaging elements (CCDs and the like), micromachines, thin-film magnetic heads, and DNA chips. The above-described light source apparatus, exposure apparatus, and electronic device manufacturing method can be also used to manufacture masks (photomasks, reticles and the like) having mask patterns of various devices by using the photolithography techniques.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

The present invention can be utilized in the semiconductor industry.

What is claimed is:

1. A light source apparatus for generating a light beam to be projected toward a fly-eye optical system included in an exposure apparatus, wherein
the light beam entering the fly-eye optical system has a lower intensity in an edge portion than in a center portion.

2. The light source apparatus as set forth in claim 1, comprising:
a light source; and
an optical system that projects the light beam emitted from the light source toward the fly-eye optical system, wherein
the optical system projects the light beam such that the light beam has a lower intensity in the edge portion than in the center portion.

3. The light source apparatus as set forth in claim 2, wherein
the optical system is a mirror that reflects the light beam toward the fly-eye optical system, and
the mirror reflects the light beam such that the light beam has a lower intensity in the edge portion than in the center portion.

4. The light source apparatus as set forth in claim 3, wherein
the mirror reflects the light beam such that the intensity of the light beam projected toward a predetermined plane at which the fly-eye optical system is positioned monotonically decreases in the edge portion.

5. The light source apparatus as set forth in claim 4, wherein
the mirror reflects the light beam such that the intensity of the light beam projected toward the predetermined plane successively decreases in the edge portion.

6. The light source apparatus as set forth in claim 4, wherein
the mirror reflects the light beam such that the intensity of the light beam projected toward the predetermined plane decreases down to zero in the edge portion.

7. The light source apparatus as set forth in claim 3, wherein
a curvature of the mirror is set so as to differ between a first portion that reflects the light beam toward a center portion of a predetermined plane at which the fly-eye optical system is positioned and a second portion that reflects the light beam toward an edge portion of the predetermined plane.

8. The light source apparatus as set forth in claim 7, wherein
a light beam emitted from the light source and reflected by the first portion on a reflective surface of the mirror reaches a different position on the predetermined plane than a light beam emitted from the light source and reflected by the second portion on the reflective surface of the mirror.

9. The light source apparatus as set forth in claim 3, wherein
the mirror has a lower reflectance in an edge portion than in a center portion.

10. The light source apparatus as set forth in claim 3, wherein
the mirror has a more roughened surface in an edge portion than in a center portion.

11. The light source apparatus as set forth in claim 3, wherein
the mirror has light block elements that are arranged more densely in an edge portion than in a center portion.

12. The light source apparatus as set forth in claim 3, wherein
a substrate that is exposed to light by the exposure apparatus is exposed to light while being moved in a scan direction, and
the mirror reflects the light beam symmetrically in a non-scan direction substantially perpendicular to the scan direction.

13. The light source apparatus as set forth in claim 3, wherein
a substrate that is exposed to light by the exposure apparatus is exposed to light while being moved in a scan direction, and
the mirror includes a plurality of mirrors arranged symmetrically in a non-scan direction substantially perpendicular to the scan direction.

14. The light source apparatus as set forth in claim 3, further comprising
a light block member that is provided on an optical path extending from the mirror to the fly-eye optical system, the light block member having light block elements arranged more densely in an edge portion than in a center portion.

15. An exposure apparatus comprising:
a light source apparatus that generates a light beam to be projected toward a fly-eye optical system, the light beam entering the fly-eye optical system having a lower intensity in an edge portion than in a center portion; and
an illumination optical system that includes the fly-eye optical system, the illumination optical system illuminating a predetermined pattern by using the light beam from the light source apparatus.

16. The exposure apparatus as set forth in claim 15, wherein
the light source apparatus includes:
a light source; and
an optical system that projects the light beam emitted from the light source toward the fly-eye optical system, and
the optical system projects the light beam such that the light beam has a lower intensity in the edge portion than in the center portion.

17. The exposure apparatus as set forth in claim 16, wherein
the optical system is a mirror that reflects the light beam toward the fly-eye optical system, and
the mirror reflects the light beam such that the light beam has a lower intensity in the edge portion than in the center portion.

18. The exposure apparatus as set forth in claim 17, wherein
the mirror reflects the light beam such that the intensity of the light beam projected toward a predetermined plane at which the fly-eye optical system is positioned monotonically decreases in the edge portion.

19. The exposure apparatus as set forth in claim 18, wherein
the mirror reflects the light beam such that the intensity of the light beam projected toward the predetermined plane successively decreases in the edge portion.

20. The exposure apparatus as set forth in claim 18, wherein
the mirror reflects the light beam such that the intensity of the light beam projected toward the predetermined plane decreases down to zero in the edge portion.

21. The exposure apparatus as set forth in claim 17, wherein
a curvature of the mirror is set so as to differ between a first portion that reflects the light beam toward a center portion of a predetermined plane at which the fly-eye optical system is positioned and a second portion that reflects the light beam toward an edge portion of the predetermined plane.

22. The exposure apparatus as set forth in claim 21, wherein
a light beam emitted from the light source and reflected by the first portion on a reflective surface of the mirror reaches a different position on the predetermined plane than a light beam emitted from the light source and reflected by the second portion on the reflective surface of the mirror.

23. The exposure apparatus as set forth in claim 17, wherein
the mirror has a lower reflectance in an edge portion than in a center portion.

24. The exposure apparatus as set forth in claim 17, wherein
the mirror has a more roughened surface in an edge portion than in a center portion.

25. The exposure apparatus as set forth in claim 17, wherein
the mirror has light block elements that are arranged more densely in an edge portion than in a center portion.

26. The exposure apparatus as set forth in claim 17, wherein
the mirror reflects the light beam symmetrically in a non-scan direction substantially perpendicular to a scan direction in which a substrate that is exposed to light is moved.

27. The exposure apparatus as set forth in claim 17, wherein
the mirror includes a plurality of mirrors arranged symmetrically in a non-scan direction substantially perpendicular to a scan direction in which a substrate that is exposed to light is moved.

28. The exposure apparatus as set forth in claim 17, further comprising
a light block member that is provided on an optical path extending from the mirror to the fly-eye optical system, the light block member having light block elements arranged more densely in an edge portion than in a center portion.

29. An electronic device manufacturing method using an exposure apparatus including:
a light source apparatus that generates a light beam to be projected toward a fly-eye optical system, the light beam entering the fly-eye optical system having a lower intensity in an edge portion than in a center portion; and
an illumination optical system that includes the fly-eye optical system, the illumination optical system illuminating a predetermined pattern by using the light beam from the light source apparatus,
the electronic device manufacturing method comprising:
exposing a substrate to light having the predetermined pattern;
developing the substrate to which the predetermined pattern has been transferred to form a mask layer shaped in accordance with the predetermined pattern on a surface of the substrate; and
processing the surface of the substrate through the mask layer.

30. The electronic device manufacturing method as set forth in claim 29, wherein
the light source apparatus includes:
a light source; and
an optical system that projects the light beam emitted from the light source toward the fly-eye optical system, and
the optical system projects the light beam such that the light beam has a lower intensity in the edge portion than in the center portion.

31. The electronic device manufacturing method as set forth in claim 30, wherein
the optical system is a mirror that reflects the light beam toward the fly-eye optical system, and
the mirror reflects the light beam such that the light beam has a lower intensity in the edge portion than in the center portion.

32. The electronic device manufacturing method as set forth in claim 31, wherein
the mirror reflects the light beam such that the intensity of the light beam projected toward a predetermined plane at which the fly-eye optical system is positioned monotonically decreases in the edge portion.

33. The electronic device manufacturing method as set forth in claim 32, wherein
the mirror reflects the light beam such that the intensity of the light beam projected toward the predetermined plane successively decreases in the edge portion.

34. The electronic device manufacturing method as set forth in claim 32, wherein
the mirror reflects the light beam such that the intensity of the light beam projected toward the predetermined plane decreases down to zero in the edge portion.

35. The electronic device manufacturing method as set forth in claim 31, wherein
a curvature of the mirror is set so as to differ between a first portion that reflects the light beam toward a center portion of a predetermined plane at which the fly-eye optical system is positioned and a second portion that reflects the light beam toward an edge portion of the predetermined plane.

36. The electronic device manufacturing method as set forth in claim 35, wherein
a light beam emitted from the light source and reflected by the first portion on a reflective surface of the mirror reaches a different position on the predetermined plane than a light beam emitted from the light source and reflected by the second portion on the reflective surface of the mirror.

37. The electronic device manufacturing method as set forth in claim 31, wherein
the mirror has a lower reflectance in an edge portion than in a center portion.

38. The electronic device manufacturing method as set forth in claim 31, wherein
the mirror has a more roughened surface in an edge portion than in a center portion.

39. The electronic device manufacturing method as set forth in claim 31, wherein
the mirror has light block elements that are arranged more densely in an edge portion than in a center portion.

40. The electronic device manufacturing method as set forth in claim 31, wherein
the mirror reflects the light beam symmetrically in a non-scan direction substantially perpendicular to a scan direction in which the substrate that is exposed to light is moved.

41. The electronic device manufacturing method as set forth in claim 31, wherein
the mirror includes a plurality of mirrors arranged symmetrically in a non-scan direction substantially perpendicular to a scan direction in which the substrate that is exposed to light is moved.

42. The electronic device manufacturing method as set forth in claim 31, wherein
the exposure apparatus further includes a light block member that is provided on an optical path extending from the mirror to the fly-eye optical system, the light block member having light block elements arranged more densely in an edge portion than in a center portion.
